(19) United States
(12) Patent Application Publication
(10) Pub. No.: US 2025/0038992 A1
(43) Pub. Date: Jan. 30, 2025

(54) IMPLEMENTING A LAYER 2 TOKEN PROTOCOL USING A LAYER 1 BLOCKCHAIN

(71) Applicant: nChain Licensing AG, Zug (CH)

(72) Inventors: Mehmet Sabir KIRAZ, Leicester (GB); Jack DAVIES, London (GB); Wai LIU, San Francisco, CA (US)

(21) Appl. No.: 18/696,884

(22) PCT Filed: Sep. 6, 2022
(86) PCT No.: PCT/EP2022/074690

§ 371 Date: Mar. 28, 2024

(30) Foreign Application Priority Data
Oct. 6, 2021 (GB) 2114285.6

(51) Int. Cl. H04L 9/32; H04L 9/00

(52) U.S. Cl. CPC H04L 9/3247; H04L 9/50

(57) ABSTRACT

A computer-implemented method of implementing a token protocol using a blockchain, wherein the method is performed by a first party and comprises: obtaining a first blockchain transaction, the first blockchain transaction comprising a first output comprising a first locking script, the first locking script comprising token data; constructing a Merkle tree based on the first locking script, wherein the token data is divided across one or more leaves of the Merkle tree; generating a first signature based on a first message comprising a Merkle root of the Merkle tree; and making the first signature available for inclusion in a second output of the first blockchain transaction.

### CROSS REFERENCE TO RELATED APPLICATIONS

This application is the U.S. National Stage of International Application No. PCT/EP2022/074690 filed on Sep. 6, 2022, which claims the benefit of United Kingdom Patent Application No. 2114285.6, filed on Oct. 6, 2021, the contents of which are incorporated herein by reference in their entireties.

### TECHNICAL FIELD

The present disclosure relates to methods of implementing a layer 2 token protocol using a layer 1 blockchain.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicized. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below.

Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

Blockchains are designed to be immutable, meaning that once a transaction is written to the blockchain, it is considered impossible to alter. However, transaction data may contain private or sensitive information which may need to be protected from unauthorized access. As another example, transaction data may contain content that is illegal in at least some jurisdictions. Data that may be considered private, sensitive, or illegal is termed “secret data” herein and which we term ‘secret’ data due to the need to avoid distributing or granting access to such data.

There are many existing token protocols that make use of the blockchain. In general, a token protocol allows for, amongst other things, the issuing, transferring and redeeming of tokens. Here, a token is a digital asset that represents ownership of a real-world asset, e.g. a car, house, cinema ticket, access card, etc. A problem may arise if a transaction containing token-related data is deemed to contain an example of the secret data discussed above. In that case, it may be necessary to prove that a transaction contained the token-related data, without revealing other parts of the transaction, e.g. the secret data. In addition, the token issuer may need to be able to attest to the issuing of the token in a way that does not make the token issuer responsible or accountable for other parts of the transaction, which may be deemed (at the time of issuing or later) to be secret data.

According to one aspect disclosed herein, there is provided a computer-implemented method of implementing a token protocol using a blockchain, wherein the method is performed by a first party and comprises: obtaining a first blockchain transaction, the first blockchain transaction comprising a first output comprising a first locking script, the first locking script comprising token data; constructing a Merkle tree based on the first locking script, wherein the token data is divided across one or more leaves of the Merkle tree; generating a first signature based on a first message comprising a Merkle root of the Merkle tree; and making the first signature available for inclusion in a second output of the first blockchain transaction.

The first party may be a token issuer (e.g. Alice) who is responsible for operating the token scheme and issuing tokens to token holders. The first message signed by the token issuer comprises the Merkle root of a Merkle tree generated based on a token script-a script containing token-related data. This means that Alice, as the token issuer, is able to deal only with the data that is pertinent to the token operation itself. This gives the token holder (e.g. Bob) the freedom to construct the rest of the transaction as he likes, while Alice benefits from Bob's increased privacy by only making herself accountable for the token-specific aspect of the transaction. This also has implications in the context of blocking transaction content. For instance, if the remaining transaction data outside of the token script were adjudged to be illicit and redacted by nodes of the blockchain network, then the token issuer would still be able to prove and evidence their role in authorising the token operation, without needing to access the redacted data. This may be achieved by Alice providing the Merkle leaves corresponding to the token script data, a Merkle proof for those leaves with respect to the Merkle root of the token script, and the first signature that signs the Merkle root.

A Merkle tree is constructed based on the script, i.e. using the script. Different parts of the script are used as different leaves of the Merkle tree. At least one leaf of the Merkle tree includes part of the token data. In some examples, a single leaf node includes the entire token data. In other examples, the token data is divided across multiple leaves. As is known in the art, leaves of the Merkle tree are hashed to form leaf hashes, pairs of leaf hashes are concatenated and hashed to form respective inner hashes. The process of concatenating and hashing pairs of inner hashes is repeated until a single hash remains—the Merkle root.

According to one aspect disclosed herein, there is provided a computer-implemented method of implementing a token protocol using a blockchain, wherein the method is performed by a second party and comprises: obtaining a first blockchain transaction, the first blockchain transaction comprising a first output comprising a first locking script, the first locking script comprising token data; constructing a transaction Merkle tree, wherein a plurality of respective leaves of the transaction Merkle tree are formed from one or more fields of the first blockchain transaction; and generating a first signature based on a first message comprising a Merkle root of the transaction Merkle tree.

The second party may be a token holder (e.g. Bob) who is a user of the token scheme, and who may own and transfer tokens that they are issued. The first transaction is a token transaction in the sense that it contains the token-related data, as part of the token script. The second transaction conveys the token holder's signature that signs a message based on the token data. Specifically, the signature signs a message comprising a Merkle root of a transaction-level Merkle tree. A transaction-level Merkle tree is a Merkle tree that is generated using fields of the token transaction, and thus encodes the token data. The message may also comprise a Merkle root of a script Merkle tree constructed based on only the token script. This benefits Bob because not only is he now able to prove he signed and participated in the token operation, but he is also able to do so at a high level of granularity. Merklizing the full transaction in the signed message allows Bob to have more control in revealing only the parts of the token script, or the rest of the transaction, that he wishes to. For example, if the token transaction is later judged to contain illicit data, Bob can prove that he signed a message that was based on the token transaction, and that the token transaction contained token data, without needing to reveal the illicit parts of the token transaction.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain;

FIG. 2 schematically illustrates some examples of transactions which may be recorded in a blockchain;

FIG. 3 schematically illustrates the structure of an example blockchain transaction containing data embedded in an unspendable output;

FIG. 4 schematically illustrates an example of Merklizing a pay-to-public-key hash (P2PKH) script;

FIG. 5 schematically illustrates an example of Merklizing an unspendable output script;

FIG. 6 schematically illustrates an example of generating a secondary identifier for a transaction,

FIG. 7 schematically illustrates a token transaction where the token issuer only signs the token-related transaction data, and

FIGS. 8A and 8B schematically illustrate a pair of transactions representing a token transfer where the token holder signs a Merklized version of the token transaction and its script(s).

### DETAILED DESCRIPTION OF EMBODIMENTS

### 1. Example System Overview

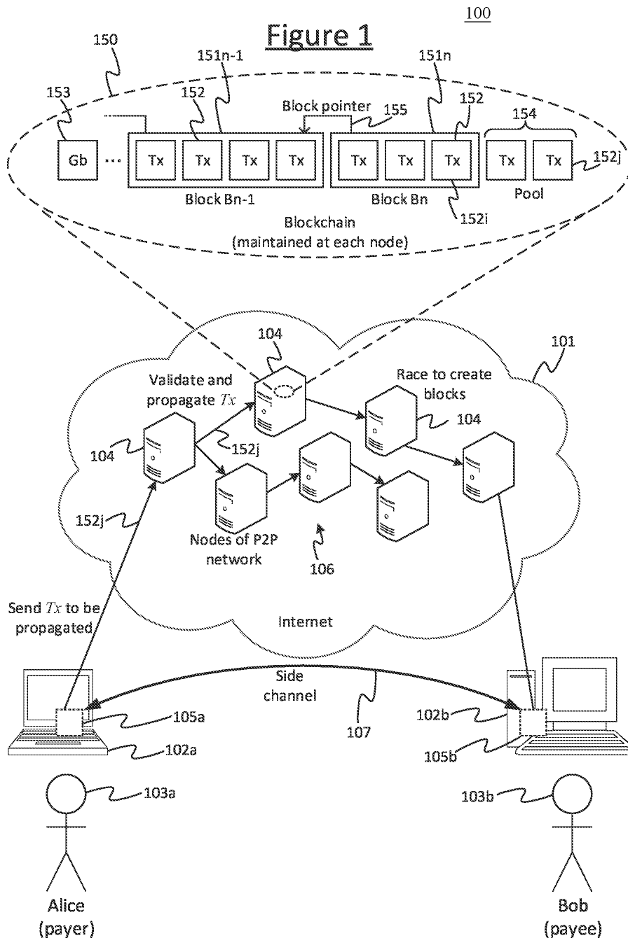

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly.

In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

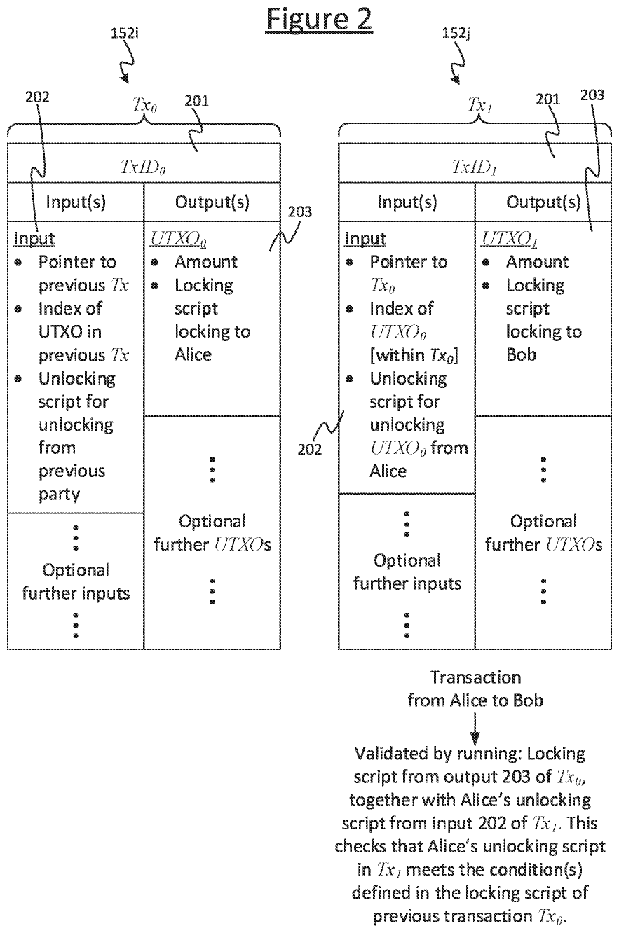

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig P_{A}><P_{A}>| | [Checksig P_{A}]
   where “|” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Token Protocol Using Merklized Scripts

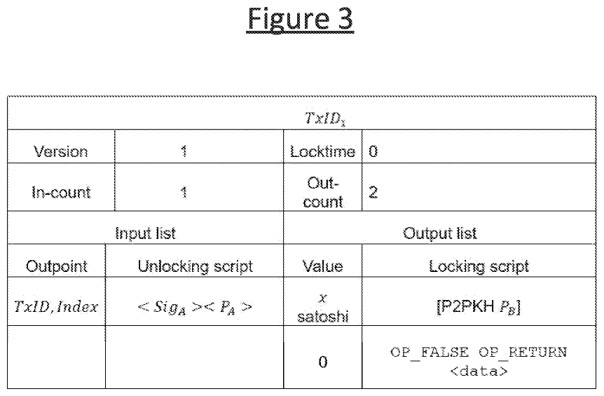

Blockchain transactions include inputs and outputs, each of which include a script. Blockchain scripts (such as Pay-to-Public-Key (P2PK), Pay-to-Public-Key-Hash (P2PKH), Multi-Signature, OP_RETURN) can be used to store arbitrary data in a transaction. In general terms, outputs contain scripts that can encode complex locking conditions, as well as storing additional data items that may or may not be part of the locking conditions. For a particular example, arbitrary data may be added to a transaction using an unspendable script pattern known as an OP_FALSE OP_RETURN output. The combination of script opcodes OP_FALSE OP_RETURN that is used to store arbitrary data on the ledger leads to an increase in the size of the blockchain and consumes the disk space of blockchain nodes 104 that wish to store the full data of the blockchain. Some data that is stored on the blockchain may be illicit, illegal, sensitive, private, etc. Some data may fall into one of those categories at the time of being recorded onto the blockchain, or at a later date. Some data may fall into one of those categories in some jurisdictions, but not others. There is therefore a need to be able to redact data from a transaction so as to decrease the size of the transaction and/or comply with (jurisdiction-dependent) rules and regulations, amongst other reasons. FIG. 3 shows the structure of an example blockchain transaction with an OP_FALSE OP_RETURN payload.

Blockchain transactions are sometimes used to convey token-related data, i.e. data relating to a digital token. A digital token typically confers ownership of a real-world asset on the holder of the token. For instance, the real-world asset may be a physical object such as a car, a house, a watch, artwork, etc. The real-world asset may be non-physical such as a digital ticket to an event, or a vote in an election. If a token transaction, i.e. a blockchain transaction containing token-related data, contains data that needs to be redacted, it is important for the token holder or token issuer to be able to prove, respectively, that they do indeed hold the token or that they did indeed issue the token.

Embodiments of the present disclosure enable a token issuer and a token holder be able to implement a token protocol, and prove that that they were party to a token transaction, in the event that other data in a token transaction is later redacted. The data to be redacted is referred to herein as “target data”. The target data may be included as part of an input (unlocking) script. For example, the transaction shown in FIG. 3 includes an unlocking script comprises the data <Sig_{A}><P_{A}>—a signature and a public key. The target data may be included as part of an output (locking) script. For example, the same transaction includes two locking scripts, both of which contain data. The first locking script includes the data P_{B}—a public key. The second locking script includes the data <data>—any arbitrary data, such as media content, personal details (e.g. name and address), invoice information, etc. The target data may be included as part of a spendable (i.e. transferrable and assignable) output or an unspendable (i.e. non-transferrable and non-assignable) output.

Some embodiments of the present disclosure use a single transaction to implement a token operation. A token operation may be the issuance, transfer, redemption, or combination of a token and involves the token issuer and the token holder. In general the token issuer may be any entity, a user, a group of users, a machine, a smart contract, etc. For simplicity, the token issuer will be referred to below as Alice 103a, and may be configured to perform any of the operations described above as being performed by Alice 103a. Similarly, the token holder may be any entity, and will be referred to below as Bob 103b, who may be configured to perform any of the operations described above as being performed by Bob 103b.

Alice 103a obtains a token transaction that contains a token script, i.e. a locking script that contains token-related data. For instance, the token-related data may include one or more of: terms and conditions of the token, an issuance date of the token, details of the token issuer, an expiry date, etc. Alice 103 may have generated at least part of the token transaction, or Alice 103a may receive the token transaction, e.g. from Bob 103b.

Alice 103a constructs a Merkle tree based on the token script that includes the token data. The entire token script is used to generate the Merkle tree. The token data forms, in its raw form, one or more leaves of the Merkle tree. That is, one or more leaves of the Merkle tree comprise (or consist of) at least part of the token data. In some examples, a single leaf may comprise (or consist of) the token data, meaning the entire token data is included as part of that leaf. Alternatively, the token data may be split across multiple leaves of the Merkle tree, meaning different leaves include a different part of the token data. For example, the token data may be split into equal size chunks, or the token data may be split into a predetermined number of chunks. The token data may instead be divided arbitrarily.

In some examples, the token script may include only the token data. In that case, the Merkle tree may be based entirely on the token data. However, in practice the token script is more likely to contain other components and not just the token data. For instance, the token script may include one or more functions that are configured to perform respective operations. On the Bitcoin blockchain these functions are known as opcodes. Additionally or alternatively, the token script may include data that is not token-related. For example, a token script may include a public key hash which may not necessarily be related to the token. In these examples, the token data only forms part of the Merkle tree, i.e. one or more leaves of the Merkle tree. The function(s) and/or other data also form part of the Merkle tree. That is, one or more leaves of the Merkle tree may comprise (or consist of) one or more functions, and one or more leaves of the Merkle tree may comprise (or consist of) non-token data.

The different components (e.g. functions, token data, other data, etc.) of the script have an order, e.g. from left to right, and that order is respected when constructing the Merkle tree. The leaves of the Merkle tree are formed using the components of the script, in the order in which they appear. For example, the script may include a first set of one or more functions, followed by the token data, followed by a second set of one or more functions. A first set of leaves of the Merkle tree are formed from the first set of functions, a second set of leaves of the Merkle tree are formed from the token data, and a third set of leaves of the Merkle tree are formed from the second set of functions.

Note that the term “Merkle tree” generally refers to a binary hash tree. However in general, embodiments of the present disclosure may utilise any type of hash tree, e.g. a tertiary hash tree. Therefore any reference to “Merkle tree” may instead by replaced by the more general “hash tree”.

In some examples, one or more consecutive functions may be grouped together to form a single leaf of the Merkle tree. In other examples, each function may form a single leaf of the Merkle tree.

In some examples, the script may include a data function (e.g. OP_PUSHDATA, OP_RETURN, etc.) that is configured to indicate the token data when executed. Indicating the token data may comprise outputting the target data to memory (e.g. a stack-based memory) when executed. In these examples, the data function may be separated from the other functions such that it is the only function included in a respective leaf of the Merkle tree. The leaf containing the data function may include other data, such as a length of the token data, e.g. in bytes. Alternatively, the length of the token data may be included as a different leaf of the Merkle tree. The length of the data may be used to determine the number of leaves of the Merkle tree.

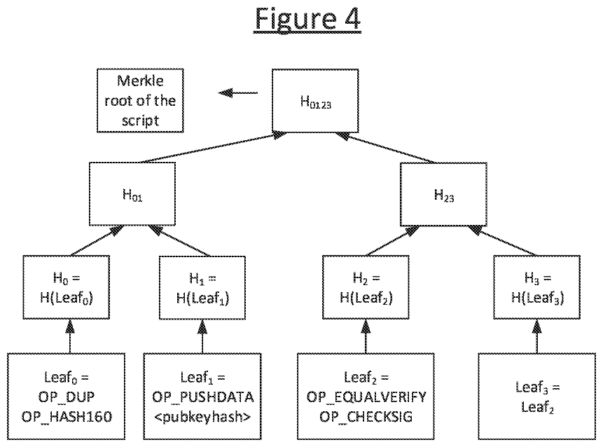

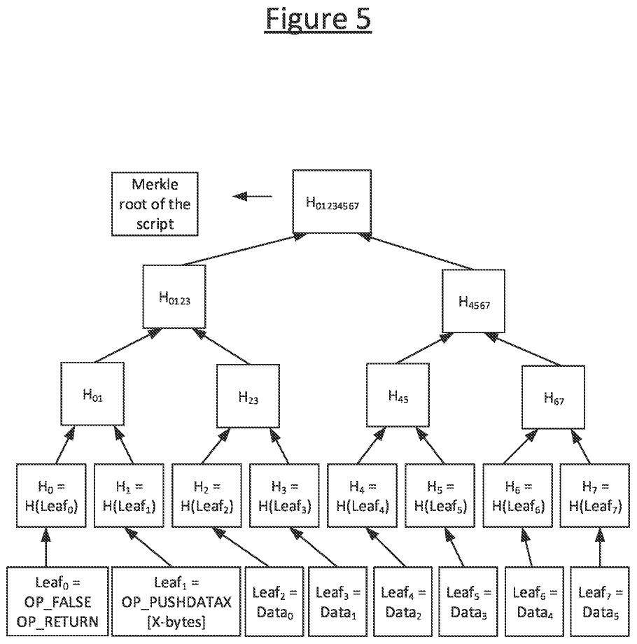

FIGS. 4 and 5, which are discussed in more detail below, illustrate the process of generating a Merkle tree based on scripts containing token data. As shown in FIG. 4, from left to right, a first group of functions (opcodes) including form a first leaf, a data function and the token data (<pubkeyhash>) form a second leaf, a second group of functions form a third leaf, and the fourth leaf is formed by duplicating the third leaf. In FIG. 5, a first data function (OP_RETURN) forms part of a first leaf, a second data function (OP_PUSHDATAX) forms part of a second leaf along with the data length ({X-bytes]), and the token data is split over six leaf nodes.

Having generated the Merkle tree based on the token script, Alice 103a signs a message that includes the Merkle root of the Merkle tree. The token data is thus encoded using the Merkle root and signed with Alice's signature. Alice 103a includes the signature in an output of the token transaction, e.g. an unspendable output. Alice 103a may then submit the token transaction to the blockchain network 106, or send the token transaction (which includes Alice's signature) to Bob 103b. Bob 103b may then submit the token transaction to the network 106. Alternatively, Alice 103a may send the signature to Bob 103b for Bob 103b to include the signature in the token transaction and send the token transaction to the network 106.

The token transaction may be signed by Bob 103b. That is, Bob 103b may sign over the entire token transaction. Bob's signature is used to unlock an output of a previous transaction, such that Bob 103b funds the token transaction. Bob's signature therefore needs to comply with the rules of the blockchain protocol.

Alice's signature may be the same type as Bob's, e.g. both signatures may be ECSDA signatures. Alternatively, Alice may use a different type of signature. Alice's signature does not need to comply with the rules of the blockchain protocol since it is included in an output of the token transaction. Hence, Alice's signature, which is referred to as a token signature, is interpreted as a layer-2 signature, with Bob's signature being a layer-1 signature.

After being submitted to the blockchain 150, the token transaction may be deemed to contain data that needs to be redacted, e.g. for privacy or legal reasons. Since Alice 103a has signed only a message based on the Merkle root of the token script and not the token transaction as a whole, Alice 103a can prove that she was not responsible for the redacted data. Alice 103a can also prove that the token transaction contained the token data that she signed. To do so, Alice 103a may provide a Merkle proof for the token data to prove that the token data formed one or more leaves of a Merkle tree corresponding to the signed Merkle root.

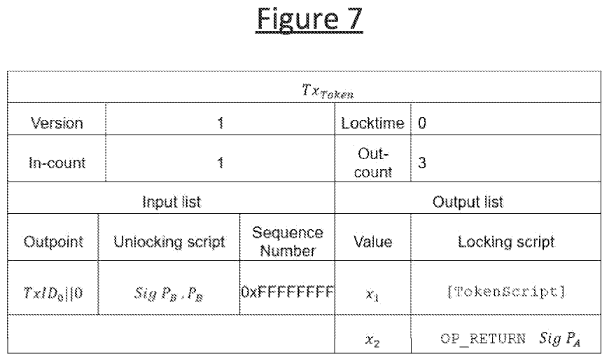

An example token transaction is shown in FIG. 7. The token transaction includes two outputs, one comprising the token script [TokenScript], and one comprising Alice's signature Sig P_{A}. In this example, Alice's signature is included in an unspendable output. The token transaction also includes Bob signature Sig P_{B} which signs the token transaction.

Some embodiments of the present disclosure use a pair of transactions to implement a token operation. A first one of the transactions is a token transaction, and is similar to the token transaction described above in that it includes a token script comprising token data. The token transaction may be signed by the token issuer Alice 103a.

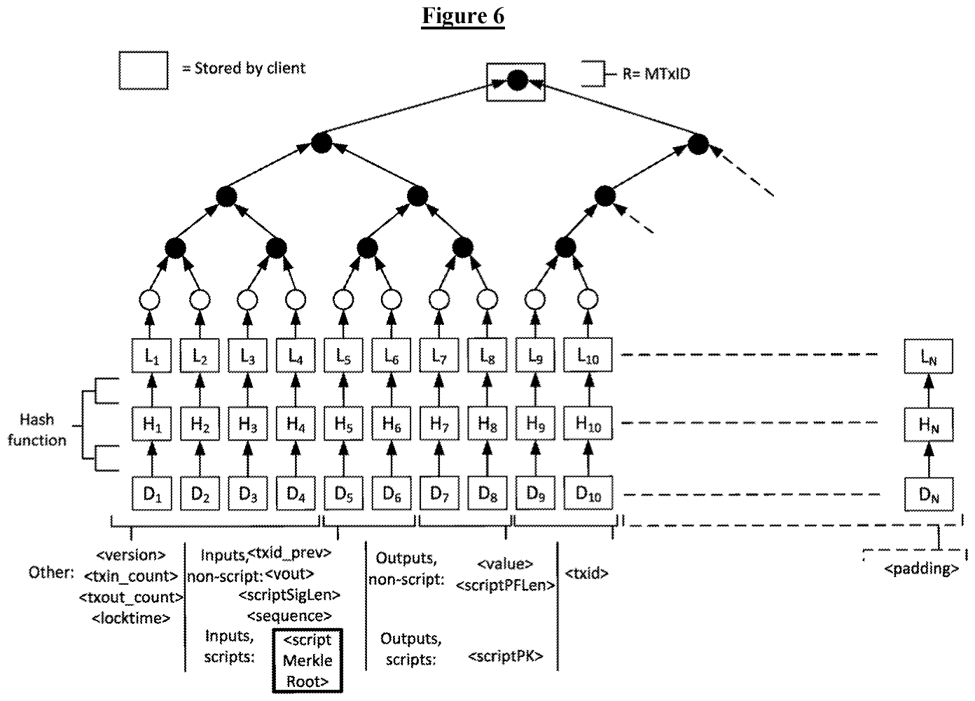

Bob 103b obtains the token transaction and constructs a Merkle tree based on the token transaction. That is, a transaction-level Merkle tree is generated, where the leaves of the Merkle tree are formed from parts of the token transaction. An example is shown in FIG. 6, where at least one of the fields of the token transaction comprises a Merkle root, e.g. the Merkle root of FIG. 3 or FIG. 4. The transaction Merkle tree has a Merkle root, which is referred to herein as a transaction Merkle root. The token transaction comprises a plurality of fields, e.g. version number, locktime, one or more inputs, one or more outputs, etc. One or more leaves may comprise some or all of a single respective field. One or more leaves may comprise some or all of multiple respective fields.

Bob 103b signs a message comprising the transaction Merkle root. Bob 103b generates a second transaction, referred to as a signature transaction, and includes his signature in the signature transaction. The token data is thus encoded using the transaction Merkle root and signed with Bob's signature. Bob 103b includes the signature in an output of the signature transaction, e.g. an unspendable output. Bob 103b may then submit the signature transaction to the blockchain network 106, or send the signature transaction to Alice 103a. Alice 103a may then submit the signature transaction to the network 106.

In some examples, Bob 103b may construct a Merkle tree based on the token script included in the token transaction, in the same way as described above from Alice's perspective. The message signed by Bob 103b may include the Merkle root of this Merkle tree. Additionally or alternatively, Bob 103b may replace the token script with the Merkle root of the Merkle tree generated based on the token script and generate the transaction Merkle tree based on the Merkle root instead of the token script. That is, prior to generating the transaction Merkle tree, Bob 103b generates a Merkle root of the token script, and replaces the token script with the Merkle root.

Bob 103b may sign the signature transaction prior to submitting the signature transaction to the blockchain network 106. Thus in these examples Bob 103b generates two signatures. The signature which signs the Merkle root(s) is referred to as a token signature. The signature which signs the signature transaction is referred to as a blockchain signature. The blockchain signature must obey the rules of the blockchain protocol, whereas the token signature does not necessarily have to obey those rules. Alice's signature may also be a blockchain signature.

After being submitted to the blockchain 150, the token transaction may be deemed to contain data that needs to be redacted, e.g. for privacy or legal reasons. Since Bob 103b signed a message based on a Merkle root of the token transaction, Bob 103b can prove that he signed and participated in the token transaction without having to reveal more than the token script, or even more than the token data. To do so, Bob 103b may provide a Merkle proof for the token data to prove that the token data formed one or more leaves of a transaction Merkle tree corresponding to the signed Merkle root.

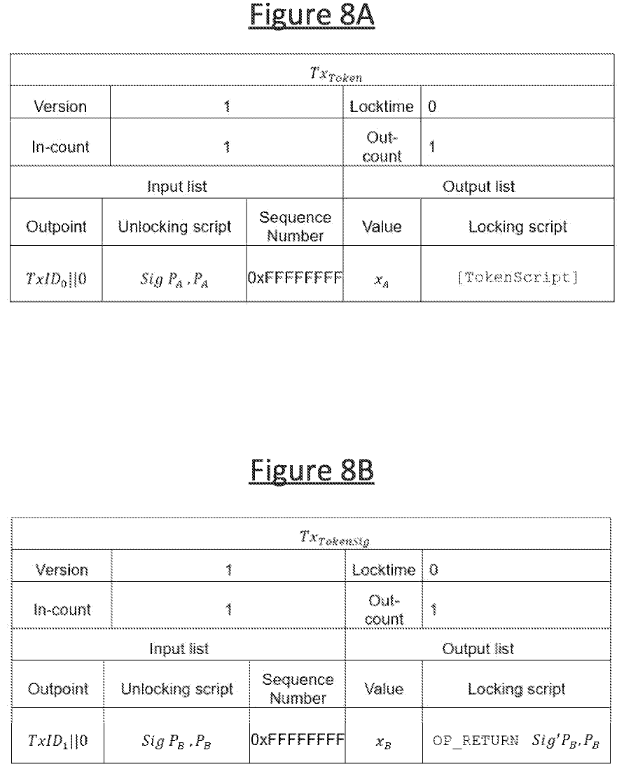

An example pair of transaction is shown in FIGS. 8A and 8B. FIG. 8A shows a token transaction which includes an output comprising the token script [TokenScript]. The token transaction is signed with Alice's signature Sig P_{A}. FIG. 8B shows a signature transaction.

In this example, Bob's token signature Sig′ P_{B} is included in an unspendable output. The signature transaction also includes Bob's blockchain signature Sig P_{B} which signs the signature transaction.

Further details of the transaction Merkle tree are now discussed. As mentioned above, a Merkle tree may be generated using fields of the token transaction in order to generate a Merkle root of the token transaction. The Merkle root may be referred to as a secondary transaction identifier, and is so-called since in most blockchain protocols, each transaction is associated with a primary transaction identifier, usually generated by hashing (or double-hashing) the entire transaction.

An example technique comprises splitting a transaction field-wise into a set of data packets (or data fields) that can be used as the leaves of a Merkle tree, with the root of the Merkle tree corresponding to the secondary transaction identifier. Here, splitting is equivalent to identifying data fields of the transaction. In other words, the transaction does not actually have to be “divided”. Instead, different parts of the transaction may be identified (e.g. assigned) as different ones of the set of data fields. The secondary transaction identifier will be unique to a given transaction (e.g. a unique 256-bit numeric representation (a hash value) of the given transaction). This hash value can be used to verify whether any individual field was a valid leaf of the Merkle tree without obtaining the entire set (i.e. the full transaction).

Given a transaction Tx, one way to verify that it has been included in a block of the blockchain is to verify that its corresponding TxID (primary transaction identifier) appears in a block. This check can done by performing a Merkle tree proof (e.g. a Merkle proof) to verify that the transaction corresponding to TxID is part of the transaction set represented by the hash root in the block header. However, this check requires the verifier to first obtain the full transaction message m=Tx and affirm that TxID=H (Tx) does in fact hold for the given Tx and the supposed TxID, where H is a hash function. This may be problematic for some users of the blockchain, in particular, when the user implements a lightweight client and/or the message m is large.

In examples a secondary transaction identifier MTxID may be generated that obeys the following definition: MTxID: =F (Tx, TxID). The algorithm F acts as a one-way function that generates a secondary transaction identifier from two input messages, Tx and TxID. Given the fact that a TxID can be written as a function of a transaction message Tx as TxID:=H²(Tx), this means MTxID can be written as a function of a single message m=Tx in the following way: MTxID:=F(Tx, H²(Tx)):=F(Tx). The algorithm F comprises a Merkle tree generator. The algorithm takes a full transaction as input Tx and returns a hash digest MTxID, which we can use as a secondary identifier for the transaction. The secondary identifier may be a 256-bit hash digest. It should be appreciated that the secondary identifier MTxID does not replace the primary identifier TxID in this scheme. To reinforce this, the design of the algorithm F includes the generation of TxID, e.g. using the typical double-hashing function H²(Tx), which binds the secondary identifier to the primary identifier.

The method for generating a secondary transaction identifier MTxID can be split into three main stages, as summarised below.

### Input: Tx

### F(Tx):

1) Calculate TxID: =H²(Tx) (note that this is an optional step).
2) Separate Tx into a set [symbol] of N=2^{k} ordered data packets, [symbol] :={D₁, D₂, . . . , D_{N}}.
3) Generate a binary Merkle tree T using the packets of set [symbol] as the leaves and calculate its root R.

### Output: MTxID=R

### Stage 1: Calculation of TxID

The method may comprise generating a primary transaction identifier by hashing the transaction. The first stage is a SHA-256 double-hash calculation, performed on the Tx, which generates the primary transaction identifier TxID. Other hash functions may be used, and in some examples only a single hash calculation is performed. Usually the Tx message itself does not include the TxID explicitly. The subsequent stages of therefore require this explicit pre-calculation of TxID, such that the Merkle tree can be constructed in a way that encodes this primary identifier explicitly.

Stage 2: Separation of Tx into Ordered Data Set

[symbol]

The transaction data comprising the message Tx is separated into discrete packets that can be used as the leaves of a Merkle tree T. The transaction may be split into its existing fields. Most of these fields contain simple numeric data which will generally be very small in size-typically ranging between 1 and 32 bytes. Therefore most of the transaction is related to the sigScript and scriptPubKey fields, which relate to inputs (unlocking) and outputs (locking) respectively. The fields of a transaction may be distinguished using three categories: input fields, output fields and other fields. In some examples, the transaction is split into these three categories, e.g. one data field comprising all input fields, one data field comprising all output fields, and one data field comprising the other fields. The input and output fields may be separated into non-script and script fields, the non-script field comprising numeric data and the script field comprising script data.

The following table shows ways in which a transaction may be split into a set of data fields.

| | Size | Input, Output or | Script or Non- |
|---|---|---|---|
| Field | (Bytes) | Other? | script? |
| version | 4 | other | |
| txin_count | 1-9 | other | |
| tx_in [ ] | | | |
| txid_prev | 32 | input | non-script |
| vout | 4 | input | non-script |
| scriptSigLen | variable | input | non-script |
| scriptSig | variable | input | script |
| sequence | 4 | input | non-script |
| txout_count | 1-9 | other | |
| txout [ ] | | | |
| value | 8 | output | non-script |
| scriptPubKeyLen | variable | output | non-script |
| scriptPubKey | variable | output | script |
| locktime | 4 | other | |

This table demonstrates that a Tx message can be split into its component fields to form a set of packets [symbol] in several ways.

In some examples, the transaction may be split into at least one data field comprising input data of the transaction (e.g. txid_prev); at least one data field comprising output data of the transaction (e.g. value); and at least one data field comprising non-input and non-output data (i.e. the other data, e.g. version) of the transaction. Each data field may consist of data of only one type, e.g. only input data.

In other examples, the transaction may be split into more data fields. For instance, the set of data fields may comprise: at least one data field comprising script input data of the transaction (e.g. scriptSig); at least one data field comprising non-script input data of the transaction (e.g. vout); at least one data field comprising script output data of the transaction of the transaction (e.g. scriptPubkey); and at least one data field comprising non-script output data of the transaction of the transaction (e.g. scriptPubKeyLen).

Note that according to the present disclosure, each scriptSig and scriptPubKey may be replaced with the corresponding Merkle root of the Merkle tree generated based on the respective script.

The transaction Tx may be split into the following set of ordered data packets:
D₁=<version>,
D₂=<txin_count>,
D₃=<txout_count>,
D₄=<locktime>,
D₅=<txid_prev>∥<vout>∥<scriptSigLen>∥<sequence>,
D₆=Merkle root of <scriptSig>,
D₇=<value>|<scriptPubKeyLen>,
D₈=Merkle root of <scriptPubKey>.

The choice to split the data in this way has several benefits if each packet Dᵢ is a leaf of a binary Merkle tree. First, all non-script inputs are concatenated to form packet D₅ and similarly all non-script outputs are concatenated to form D₇. This means that every input and output of a transaction is split into exactly two parts—the non-script component and the script component (or rather, the Merkle root thereof). This is advantageous as it means every input and output can be paired as sibling leaves. The inputs and outputs may therefore be separated from other fields entirely, and the script and non-script components of each input or output may also be separated.

In addition to these fields, the TxID may also be included as a leaf in the Merkle tree T. Following on from the above example, this means include the data field D₉=<TxID>. In general, there may be many inputs and many outputs in a transaction, each of which may be split into two components by the algorithm F. The total number of data blocks N=| [symbol] | in this tree T will therefore be given by the equation

$$N = {\underbrace{4}}_{\begin{matrix}Other \\ fields\end{matrix}} + {\underbrace{( 2 \times {n}_{in} )}}_{input fields} + {\underbrace{( 2 \times {n}_{out} )}}_{output fields} + {\underbrace{1}}_{TxID} ,$$

where nᵢₙ, nₒᵤₜ are the number of transaction inputs and outputs respectively. In some examples, all the other data fields may be concatenated to form a single data field. This reduces the total number of leaves to N=2+2 (nᵢₙ+nₒᵤₜ).

In the case that there is no k∈ [symbol] * such that N=2^{k}, 2^{k}−N>0 data packets of null padding data may be added to ensure there are enough leaves of the Merkle tree. This padding could either be null data or it could be 2^{k}−N copies of the TxID so as to reinforce the link between the primary transaction identifier and the eventual secondary identifier MTxID.

Stage 3: Generation of the Merkle tree T using [symbol] and calculation of root R

The method comprises using the set of data fields as leaves of a transaction Merkle tree. The transaction Merkle tree comprises a leaf layer, one or more internal layers and a root layer. The leaf layer comprises a plurality of leaf nodes (also referred to as leaf hashes as each node is a hash digest). Each leaf node is generated by hashing a respective data field of the transaction. At least one of the leaf hashes is based on the primary transaction identifier. In some examples, one or more leaf hashes are generated by hashing the primary transaction identifier. In some examples, one or more fields of the transaction are concatenated with the primary transaction identifier and then hashed to generate respective leaf hashes. Each internal layer comprises a plurality of internal nodes (or internal hashes). Each internal hash in a given internal layer is generated by hashing a concatenation of at least two hashes from a lower layer. E.g. the first or lowermost internal layer (i.e. the internal layer connected directly to the leaf layer) comprises internal nodes generated by hashing a concatenation of at least two leaf hashes. The root layer comprises a Merkle root of the transaction tree, i.e. the secondary transaction identifier. The secondary transaction identifier is generated by hashing a concatenation of the internal hashes of an uppermost internal layer of the one or more internal layers (i.e. the internal layer connected directly to the root layer).

The algorithm F takes the ordered set of data packets [symbol] and constructs a Merkle tree T by using these packets as the leaves. FIG. 8 shows an example construction of a binary Merkle tree. In this example the first four data fields D₁, . . . , D₄ are the other fields of a transaction, the next 2×(nᵢₙ+nₒᵤₜ) data fields are the input and output fields represented as pairs of script D₅, D₆ and non-script D₇, D₈ field data. The remaining data fields include at least one field D₉, D₁₀ containing TxID and any padding D_{N} required to reach N=2^{k} for some integer k.

### 5. Example Privacy-Preserving Token Scheme

This section provides an example of how the embodiments described above can be implemented to enable a privacy-preserving token protocol.

This example scheme is a privacy-preserving token scheme where tokens require valid signatures for standard token-related operations such as transfer, melt, mint, and combination. In this scheme there are two classes of participant:
Token issuer (Alice)—responsible for operating the token scheme and issuing tokens to token holders.
Token holder (Bob)—a typical user of the token scheme, who may own and transfer tokens they are issued.

It is expected that Alice 103a and Bob 103b may be involved in each token operation, and the concept of signatures that sign over Merklized transaction scripts is applied to ensure that the scheme has a privacy benefit for at least one of the two participants.

In this section, we separately consider the cases where (I) the token issuer, and (II) the token holder, are the primary beneficiary of this privacy advantage. However, in both cases the scheme is privacy-preserving in the sense that we construct these signatures such that the signed message is based on the Merklized form of the transaction. This has the benefit that it can be proven that the token-related data in the transaction was part of the signed message, without revealing anything about the rest of the signed data in the transaction. This allows a third-party to verify the chain of token signatures using only the token-related data i.e. only the data relevant to the token transfer within a blockchain transaction. This affords token users greater privacy by allowing the transactors to keep private records of the remaining transaction data.

This is particularly effective under the assumption that many blockchain nodes 104 will prune blockchain data that is not required to validate further transactions. Under this assumption, the non-token data of token-related transactions may be pruned by blockchain nodes, meaning that only the parties to these token transactions may still have a copy of the full transaction data. This protocol enables them to prove the chain of token-spending without disclosing all of this additional data.

The transactions used to convey token operations contain two signatures, which we will call the blockchain signature and the token signature respectively.

The blockchain signature may be a typical ECDSA signature that is subject to the (layer-1) blockchain ruleset (i.e. must be valid when checked by OP_CHECKSIG) and is used to ensure the token transaction is valid for inclusion in the blockchain according to at least one of the two participants. This signature therefore signs over the usual transaction data, which may include the token-specific data stored within it.

The token signature can be a digital signature of any type as chosen for a particular token system implementation. This signature is subject to the (layer-2) ruleset of the token system, and it is used to evidence the other participant's approval of the token transaction. We exploit the script Merklization technique to allow this signature to sign over the Merklized form of a transaction and/or its scripts. This allows us to construct token signatures such that the signature can be verified but without disclosing/knowing the signed message in full. The token signature is the mechanism for ensuring the privacy benefits of our token scheme.

### 5.1 Token Issuer (Alice) Benefits

In this case, the blockchain signature Sig P_{B} is constructed by the token holder Bob, while the token signature Sig P_{A} is constructed by the token issuer Alice. A typical token transaction Tx_{Token} is shown in FIG. 7, where

$${m}_{sig {P}_{B} = [ SIGHASH ( {T}_{{x}_{Token}} ) ]}$$

$${m}_{sig {P}_{A} = [ {SIGHASH}^{′} ( {T}_{{x}_{Token}} ) ] = [ scriptMerklize ( TokenScript ) ] = [ {R}_{TokenScript} ]}$$

The first output of Tx_{Token} contains a script labelled [TokenScript], which comprises the token-specific data of the token transaction. The token holder signs a message m_{Sig P}_{_{B}} that covers the entire transaction. By contrast, the message m_{Sig P}_{_{A}} signed by the issuer is the script Merkle root R_{TokenScript} of the token script.

An advantage here is that Alice, as the token issuer, is able to deal only with the data that is pertinent to the token operation itself. This gives Bob the freedom to construct the rest of the transaction as he likes, while Alice benefits from Bob's increased privacy by only making herself accountable for the token-specific aspect of the transaction. This also has implications in the context of blocking transaction content. For instance, if the remaining transaction data outside of the token script were adjudged to be illicit and redacted by network nodes, then the token issuer would still be able to prove and evidence their role in authorising the token opera rations themselves, without needing to access the redacted data. This may be achieved simply by Alice providing the Merkle leaves corresponding to the token script data, a Merkle proof for those leaves w.r.t R_{TokenScript}, and the signature Sig P_{A}.

### 5.2 Token Holder (Bob) Benefits

In another scenario, we may grant Bob additional privacy benefits allowing him to create the token signature instead. This may be achieved by swapping the participants' roles in generating signatures in the previous case. However, a more advanced option involves two transactions. The first transaction Tx_{Token} is the same as before, but with the token signature removed such that it only conveys the token script information. The second transaction Tx_{TokenSig} is introduced to convey Bob's token signature separately. These two transactions are shown in FIGS. 8A and 8B, where

$${m}_{sig {P}_{A} = [ SIGHASH ( {T}_{{x}_{Token}} ) ]}$$

$${m}_{sig {P}_{B} = [ SIGHASH ( {T}_{{x}_{TokenSig}} ) ]}$$

$${m}_{\begin{matrix}{sig}^{′} {P}_{B} = [ SIGHASH ( {T}_{{x}_{Token}} ) ] = \\ [ Merklize ( {T}_{{x}_{Token}} ) ] ‖ [ scriptMerklize ( TokenScript ) ] = [ {R}_{Token} ] ‖ [ {R}_{TokenScript} ]\end{matrix}}$$

In this case, Bob's token signature is labelled Sig′P_{B} and is included as an OP_RETURN data payload in the second transaction. The message m_{Sig′ P}_{_{B}} signed by Bob is the Merkle root of the token transaction combined with the script Merkle root of the token script. Note that we could have just used the former, but this gives Bob the option for shorter proofs. This scenario benefits Bob because not only is he now able to prove he signed and participated in the token operation, but he is also able to do so at a much higher level of granularity. This allows Bob to have more control in revealing only the parts of the token script, or the rest of the transaction, that he wishes to. Using two transactions in this scenario enables Bob to be able to sign over the token transaction in its entirety.

### 5.3 Signalling Token Signatures

Given that token signatures do not need to be subjected to the blockchain ruleset, a signalling mechanism may be used to distinguish these signatures from standard blockchain
compatible ECDSA signatures in script. Two example measures that could be taken are the following:
   SIGHASH flag—as token signatures use a modified message serialisation algorithm, a bespoke SIGHASH flag may be applied to token signatures in an analogous fashion to those already used for layer-1 blockchain signatures. Note that this flag may not be recognised by blockchain software, and instead would signal to off-chain software that a token-specific message serialisation has been used.
   Version number—the built-in version numbers used in blockchain may also be re-purposed to signal that a transaction contains a token signature. For example, by including a token-specific version number in the version field of a token transaction, an off-chain agent can apply the layer-2 ruleset specific to the token scheme when parsing and processing a token transaction.

### 6. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method of implementing a token protocol using a blockchain, wherein the method is performed by a first party and comprises:
obtaining a first blockchain transaction, the first blockchain transaction comprising a first output comprising a first locking script, the first locking script comprising token data;
constructing a Merkle tree based on the first locking script, wherein the token data is divided across one or more leaves of the Merkle tree;
generating a first signature based on a first message comprising a Merkle root of the Merkle tree; and
making the first signature available for inclusion in a second output of the first blockchain transaction.

Statement 2. The method of statement 1, wherein the first locking script comprises one or more functions, and wherein said constructing of the Merkle tree comprises grouping one or more respective sequences of consecutive functions as respective leaves of the Merkle tree.

Statement 3. The method of statement 2, wherein the first locking script comprises a data function configured to indicate the token data executed, and wherein said constructing of the Merkle tree comprises including the data function as part of a respective leaf of the respective Merkle tree.

Statement 4. The method of statement 3, wherein the first locking script comprises a data length of the token data, and wherein said constructing of the Merkle tree is based on the data length.

Statement 5. The method of statement 4, wherein said constructing of the Merkle tree comprises including the data length as part of the same respective leaf of the Merkle tree as the data function.

Statement 6. The method of any preceding statement, wherein the token data is divided across a plurality of the respective leaves of the Merkle tree.

Statement 7. The method of any preceding statement, wherein said making of the first signature available for inclusion in the second output of the first blockchain transaction comprises including the first signature in the second output.

Statement 8. The method of any preceding statement, wherein obtaining the first blockchain transaction comprises generating the first blockchain transaction.

Statement 9. The method of any of statements 1 to 7, wherein obtaining the first blockchain transaction comprises receiving the first blockchain transaction from a second party.

Statement 10. The method of any preceding statement, wherein the first blockchain transaction comprises a second signature generated by the second party, wherein the second signature is based on a second message, the second message being based on the first blockchain transaction.

Statement 11. The method of any preceding statement, comprising submitting the first blockchain transaction to one or more blockchain nodes of a blockchain network.

Statement 12. The method of any of statements 1 to 10, comprising sending the first blockchain transaction to the second party for submitting to one or more blockchain nodes of a blockchain network.

Statement 13. The method of statement 11 or statement 12, comprising sending, to a requesting party, a Merkle proof for the token data.

Statement 14. The method of statement 10 or any statement dependent thereon, wherein the first and second signatures are different types of signatures.

Statement 15. A computer-implemented method of implementing a token protocol using a blockchain, wherein the method is performed by a second party and comprises:
obtaining a first blockchain transaction, the first blockchain transaction comprising a first output comprising a first locking script, the first locking script comprising token data;
constructing a transaction Merkle tree, wherein a plurality of respective leaves of the transaction Merkle tree are formed from one or more fields of the first blockchain transaction; and
generating a first signature based on a first message comprising a Merkle root of the transaction Merkle tree.

Statement 16. The method of statement 15, comprising generating a second blockchain transaction, wherein the second blockchain transaction comprises a first output comprising the first signature.

Statement 17. The method of statement 15, comprising including the first signature as part of the first blockchain transaction.

Statement 18. The method of statement 16 or any statement dependent thereon, comprising:
constructing a script Merkle tree based on the first locking script, wherein the token data is divided across one or more leaves of the Merkle tree, and wherein the first message comprises a Merkle root of the script Merkle tree.

Statement 19. The method of statement 18, wherein the first locking script comprises one or more functions, and wherein said constructing of the script Merkle tree comprises grouping one or more respective sequences of consecutive functions as respective leaves of the script Merkle tree.

Statement 20. The method of statement 19, wherein the first locking script comprises a data function configured to indicate the token data when executed, and wherein said constructing of the script Merkle tree comprises including the data function as part of a respective leaf of the respective script Merkle tree.

Statement 21. The method of statement 19 wherein the first locking script comprises a data length of the token data, and wherein said constructing of the script Merkle tree is based on the data length.

Statement 22. The method of statement 21, wherein said constructing of the script Merkle tree comprises including the data length as part of the same respective leaf of the script Merkle tree as the data function.

Statement 23. The method of statement 18 or any statement dependent thereon, wherein the token data is divided across a plurality of the respective leaves of the script Merkle tree.

Statement 24. The method of statement 18 or any statement dependent thereon, wherein a field of the first blockchain transaction comprises the first output, and wherein the first locking script is replaced with the Merkle root of the script Merkle tree when constructing the transaction Merkle tree.

Statement 25. The method of statement 1276 or any statement dependent thereon, comprising submitting the second blockchain transaction to one or more blockchain nodes of a blockchain network.

Statement 26. The method of statement 27 or any statement dependent thereon, comprising:
generating a second signature based on a second message, the second message being based on the second blockchain transaction; and
including the second signature in an input of the second blockchain transaction.

Statement 27. The method of statement 16 or any statement dependent thereon, wherein the first transaction comprises a third signature based on a third message, the third message being based on the first blockchain transaction.

Statement 28. The method of statement 26 or statement 27, wherein the first and second signatures are different types of signatures

Statement 29. The method of statement 27 or statement 28, wherein the first and third signatures are different types of signatures.

Statement 30. The method of statement 17 or any statement dependent thereon, wherein one or more leaves of the transaction Merkle tree are formed from multiple fields of the second blockchain transaction.

Statement 31. The method of statement 17 or any statement dependent thereon, wherein one or more leaves of the transaction Merkle tree are formed from a single field of the second blockchain transaction.

Statement 32. The method of statement 17 or any statement dependent thereon, wherein one or more leaves of the transaction Merkle tree are formed from a respective part of a respective field of the second blockchain transaction, but not the complete respective field.

Statement 33. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 32.

Statement 34. A computer program embodied on computer-readable storage and configured so as, when run on one or more processors, to perform the method of any of statements 1 to 32.

1. A computer-implemented method of implementing a token protocol using a blockchain, wherein the method is performed by a first party and comprises:
obtaining a first blockchain transaction, the first blockchain transaction comprising a first output comprising a first locking script, the first locking script comprising token data;
constructing a Merkle tree based on the first locking script, wherein the token data is divided across one or more leaves of the Merkle tree;
generating a first signature based on a first message comprising a Merkle root of the Merkle tree; and
making the first signature available for inclusion in a second output of the first blockchain transaction.

2. The method of claim 1, wherein the first locking script comprises one or more functions, and wherein said constructing of the Merkle tree comprises grouping one or more respective sequences of consecutive functions as respective leaves of the Merkle tree.

3. The method of claim 2, wherein the first locking script comprises a data function configured to indicate the token data executed, and wherein said constructing of the Merkle tree comprises including the data function as part of a respective leaf of the respective Merkle tree.

4. The method of claim 3, wherein the first locking script comprises a data length of the token data, and wherein said constructing of the Merkle tree is based on the data length.

5. The method of claim 4, wherein said constructing of the Merkle tree comprises including the data length as part of the same respective leaf of the Merkle tree as the data function.

6. The method of claim 1, wherein the token data is divided across a plurality of the respective leaves of the Merkle tree.

7. The method of claim 1, wherein said making of the first signature available for inclusion in the second output of the first blockchain transaction comprises including the first signature in the second output.

8. The method of claim 1, wherein obtaining the first blockchain transaction comprises generating the first blockchain transaction.

9. The method of claim 1, wherein obtaining the first blockchain transaction comprises receiving the first blockchain transaction from a second party.

10. The method of claim 1, wherein the first blockchain transaction comprises a second signature generated by the second party, wherein the second signature is based on a second message, the second message being based on the first blockchain transaction.

11. The method of claim 1, comprising submitting the first blockchain transaction to one or more blockchain nodes of a blockchain network.

12. The method of claim 1, comprising sending the first blockchain transaction to the second party for submitting to one or more blockchain nodes of a blockchain network.

13. The method of claim 11, comprising sending, to a requesting party, a Merkle proof for the token data.

14. The method of claim 10, wherein the first and second signatures are different types of signatures.

15. A computer-implemented method of implementing a token protocol using a blockchain, wherein the method is performed by a second party and comprises:
obtaining a first blockchain transaction, the first blockchain transaction comprising a first output comprising a first locking script, the first locking script comprising token data;
constructing a transaction Merkle tree, wherein a plurality of respective leaves of the transaction Merkle tree are formed from one or more fields of the first blockchain transaction; and
generating a first signature based on a first message comprising a Merkle root of the transaction Merkle tree.

16-32. (canceled)

33. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs to a method comprising:
obtaining a first blockchain transaction, the first blockchain transaction comprising a first output comprising a first locking script, the first locking script comprising token data;
constructing a Merkle tree based on the first locking script, wherein the token data is divided across one or more leaves of the Merkle tree;
generating a first signature based on a first message comprising a Merkle root of the Merkle tree; and
making the first signature available for inclusion in a second output of the first blockchain transaction.

34. A computer program embodied on non-transitory computer-readable storage media and configured so as, when run on one or more processors, the one or more processors perform a method of comprising:
obtaining a first blockchain transaction, the first blockchain transaction comprising a first output comprising a first locking script, the first locking script comprising token data;
constructing a Merkle tree based on the first locking script, wherein the token data is divided across one or more leaves of the Merkle tree;
generating a first signature based on a first message comprising a Merkle root of the Merkle tree; and
making the first signature available for inclusion in a second output of the first blockchain transaction.
